(19) United States
(12) Patent Application Publication
(10) Pub. No.: US 2025/0196574 A1
(43) Pub. Date: Jun. 19, 2025

(54) VEHICLE INTERIOR CLIMATE CONTROL BASED ON OCCUPANCY

(71) Applicant: GM GLOBAL TECHNOLOGY OPERATIONS LLC, Detroit, MI (US)

(72) Inventors: Rupesh Sonu Kakade, West Bloomfield, MI (US); Richard L. Worden, Ann Arbor, MI (US); Todd M. Tumas, Grosse Ile, MI (US); Michael J. Melaragni, Rochester, MI (US)

(73) Assignee: GM GLOBAL TECHNOLOGY OPERATIONS LLC, Detroit, MI (US)

(21) Appl. No.: 18/538,311

(22) Filed: Dec. 13, 2023

(51) Int. Cl. B60H 1/00

(52) U.S. Cl. CPC B60H 1/00742

(57) ABSTRACT

In an exemplary embodiment, a system is provided that includes one or more sensors and a processor. The one or more sensors are configured to obtain sensor data as to a location of one or more passengers in a vehicle. The processor is coupled to the one or more sensors, and is configured to at least facilitate controlling, via instructions provided by the processor, a climate control system of the vehicle based on the location of the one or more passengers in the vehicle.

### INTRODUCTION

The technical field generally relates to vehicles and, more specifically, to methods and systems for controlling climate control systems for vehicles.

Many vehicles today have climate control systems, such as one or more heating, ventilation, and air conditioning (HVAC) systems. However, existing techniques may not always provide optimal control of the HVAC under certain conditions.

Accordingly, it is desirable to provide improved methods and systems for controlling climate control systems, such as HVAC systems, of a vehicle. Furthermore, other desirable features and characteristics of the present disclosure will become apparent from the subsequent detailed description and the appended claims, taken in conjunction with the accompanying drawings and the foregoing technical field and background.

### SUMMARY

In accordance with an exemplary embodiment, a method is provided that includes obtaining sensor data via one or more sensors of a vehicle as to a location of one or more passengers in the vehicle; and controlling, via instructions provided by a processor, a climate control system of the vehicle based on the location of the one or more passengers in the vehicle.

Also in an exemplary embodiment, the method further includes determining, via the processor, one or more unoccupied regions of the vehicle, based on the sensor data; and restricting, via the instructions provided by the processor, air flow from the climate control system to the one or more unoccupied regions.

Also in an exemplary embodiment, the method further includes obtaining additional sensor data pertaining to climate control of the vehicle, including temperature data via one or more temperature sensors and user inputs via one or more user interfaces; calculating, via the processor a cabin air temperature error based on the additional sensor data; and limiting the restricting of the air flow to the one or more unoccupied regions, via the instructions providing by the processor, based on the cabin air temperature error.

Also in an exemplary embodiment, the method further includes determining, via the processor, a temperature of a windshield of the vehicle based on the additional sensor data; and further limiting the restricting of the air flow to the one or more unoccupied regions, via the instructions providing by the processor, based also on the temperature of the windshield.

Also in an exemplary embodiment, the method further includes determining, via the processor, when a user override has occurred to the climate settings of one or more unoccupied regions; and terminating the restricting of the air flow to the one or more unoccupied regions, via the instructions providing by the processor, when the user override is determined to have occurred.

Also in an exemplary embodiment, the method further includes determining, via the processor, one or more occupied regions of the vehicle, based on the sensor data; and increasing, via the instructions provided by the processor, the air flow from the climate control system to the one or more occupied regions to maintain thermal comfort of the occupants in the occupied regions.

Also in an exemplary embodiment, the method further includes obtaining additional sensor data pertaining to climate control of the vehicle, including temperature data via one or more temperature sensors and user inputs via one or more user interfaces; calculating, via the processor a cabin air temperature error based on the additional sensor data; determining, via the processor, a temperature of a windshield of the vehicle based on the additional sensor data; and limiting the increasing of the air flow to the one or more occupied regions, via the instructions providing by the processor, based on the cabin air temperature error and the temperature of the windshield.

Also in an exemplary embodiment, the step of determining the one or more unoccupied regions includes determining one or more unoccupied seats of the vehicle based on the sensor data; and the step of restricting the air flow includes restricting, via the instructions provided by the processor, the air flow from the climate control system to the one or more unoccupied seats.

Also in an exemplary embodiment, the step of obtaining the sensor data includes door sensor data that is representative of opening and closing one or more doors of the vehicle, via one or more door sensors of the vehicle; and the step of determining the one or more unoccupied seats includes determining, via the processor, the one or more unoccupied seats based on the door sensor data.

In another exemplary embodiment, a system is provided that includes one or more sensors and a processor. The one or more sensors are configured to obtain sensor data as to a location of one or more passengers in a vehicle. The processor is coupled to the one or more sensors, and is configured to at least facilitate controlling, via instructions provided by the processor, a climate control system of the vehicle based on the location of the one or more passengers in the vehicle.

Also in an exemplary embodiment, the processor is further configured to at least facilitate determining one or more unoccupied regions of the vehicle, based on the sensor data; and restricting, via the instructions provided by the processor, air flow from the climate control system to the one or more unoccupied regions.

Also in an exemplary embodiment, system further includes additional sensors configured to obtain additional sensor data pertaining to climate control of the vehicle, wherein the additional sensors include one or more temperature sensors configured to obtain temperature data; and one or more user interfaces configured to obtain user inputs; and wherein the processor is further configured to at least facilitate calculating a cabin air temperature error based on the additional sensor data; and limiting the restricting of the air flow to the one or more unoccupied regions, via the instructions providing by the processor, based on the cabin air temperature error.

Also in an exemplary embodiment, the processor is further configured to at least facilitate determining a temperature of a windshield of the vehicle based on the additional sensor data; and further limiting the restricting of the air flow to the one or more unoccupied regions, via the instructions providing by the processor, based also on the temperature of the windshield.

Also in an exemplary embodiment, the processor is further configured to at least facilitate determining when a user override has occurred to the climate settings of one or more unoccupied regions; and terminating the restricting of the air flow to the one or more unoccupied regions, via the instructions providing by the processor, when the user override is determined to have occurred, to maintain thermal comfort of the occupants in the occupied regions.

Also in an exemplary embodiment, the processor is further configured to at least facilitate determining one or more occupied regions of the vehicle, based on the sensor data; and increasing, via the instructions provided by the processor, the air flow from the climate control system to the one or more occupied regions.

Also in an exemplary embodiment, the system further includes additional sensors configured to obtain additional sensor data pertaining to climate control of the vehicle, wherein the additional sensors include: one or more temperature sensors configured to obtain temperature data; and one or more input sensors configured to obtain user inputs as part of a user interface; and wherein the processor is further configured to at least facilitate calculating a cabin air temperature error based on the additional sensor data; determining, via the processor, a temperature of a windshield of the vehicle based on the additional sensor data; and limiting the increasing of the air flow to the one or more occupied regions, via the instructions providing by the processor, based on the cabin air temperature error and the temperature of the windshield.

Also in an exemplary embodiment, the processor is further configured to at least facilitate determining one or more unoccupied seats of the vehicle based on the sensor data; and restricting, via the instructions provided by the processor, the air flow from the climate control system to the one or more unoccupied seats.

Also in an exemplary embodiment, the one or more sensors include one or more door sensors configured to obtain door sensor data that is representative of opening and closing one or more doors of the vehicle; and the processor is further configured to at least facilitate determining, via the processor, the one or more unoccupied seats based on the door sensor data.

In another exemplary embodiment, a vehicle is provided that includes a climate control system, one or more sensors, and a processor. The one or more sensors are configured to obtain sensor data as to a location of one or more passengers in the vehicle. The processor is coupled to the one or more sensors, and is configured to at least facilitate controlling, via instructions provided by the processor, the climate control system based on the location of the one or more passengers in the vehicle.

Also in an exemplary embodiment, the vehicle further includes one or more doors, and wherein the one or more sensors include one or more door sensors that are configured to obtain door sensor data that is representative of opening and closing one or more of the doors of the vehicle; and the processor is further configured to at least facilitate determining one or more unoccupied seats of the vehicle based on the door sensor data; and restricting, via the instructions provided by the processor, air flow from the climate control system to the one or more unoccupied seats.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes a climate control system and a control system for controlling the climate control system based on occupancy of passengers in the vehicle;

FIG. 2 is a flowchart of process for controlling a climate control system of a vehicle based on occupancy of passengers in the vehicle, and that can be implemented in connection with the vehicle of FIG. 1, including the climate control system and the control system of FIG. 1, and components thereof, in accordance with exemplary embodiments;

FIG. 3 is a flowchart of a step of the process of FIG. 2, namely determining occupancy of passengers in the vehicle, in accordance with exemplary embodiment;

FIG. 4A and FIG. 4B depict exemplary implementations of the control of the climate control system based on the occupancy of passengers in the vehicle in accordance with the process of FIG. 2; and

FIGS. 5A and 5B (collectively referred to herein as FIG. 5) and FIGS. 6A and 6B (collectively referred to herein as FIG. 6) depict exemplary implementations of certain steps of the process of FIG. 2, namely, (i) adjusting climate control of occupied regions; and (ii) adjusting climate control of unoccupied regions, respectively.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

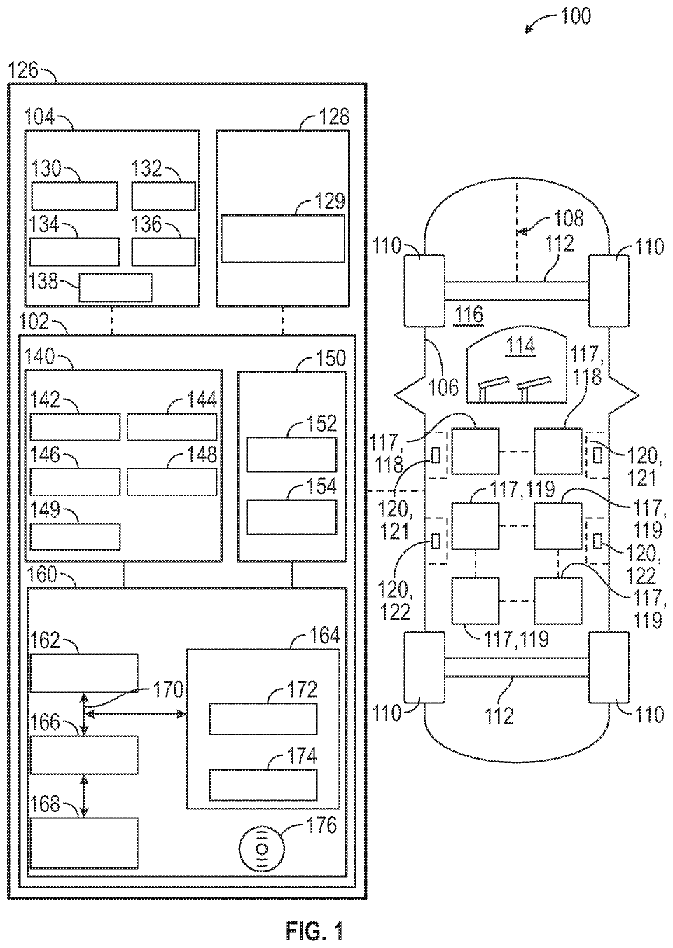

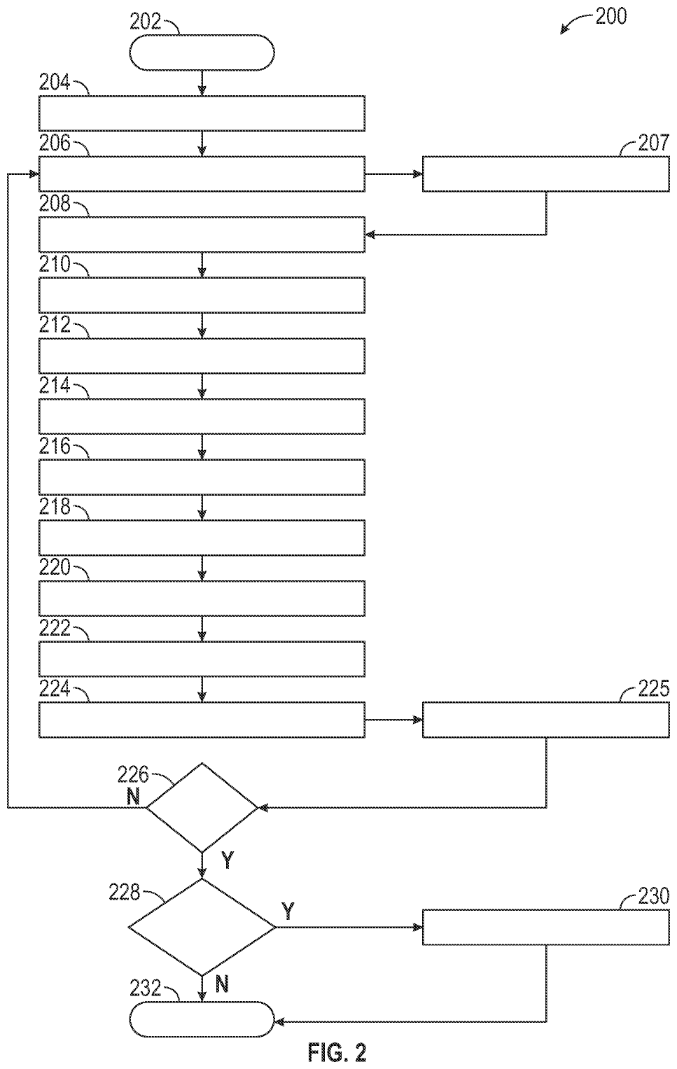

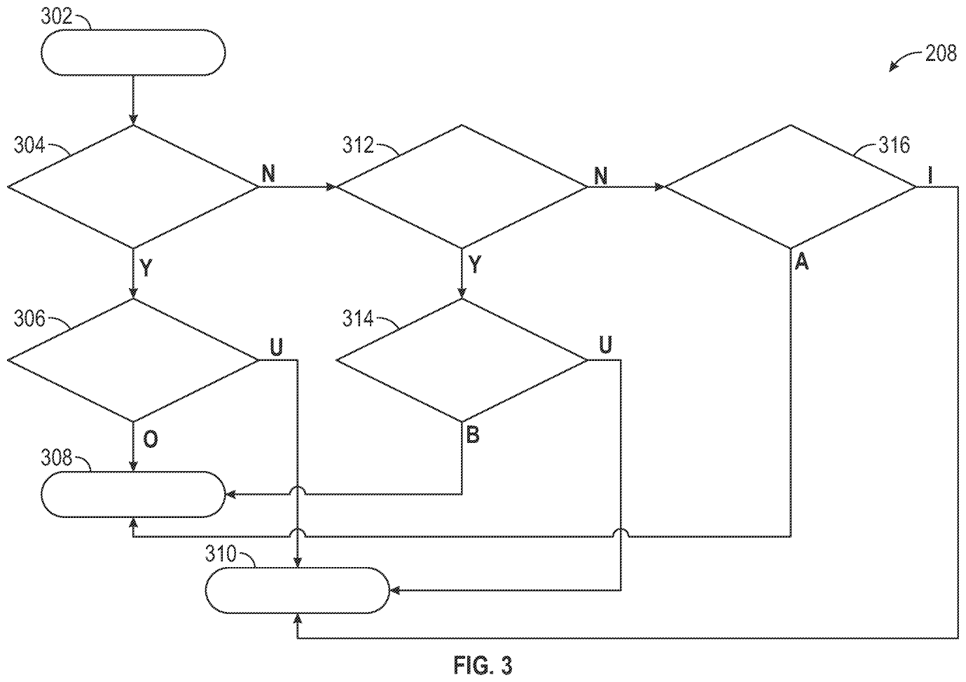

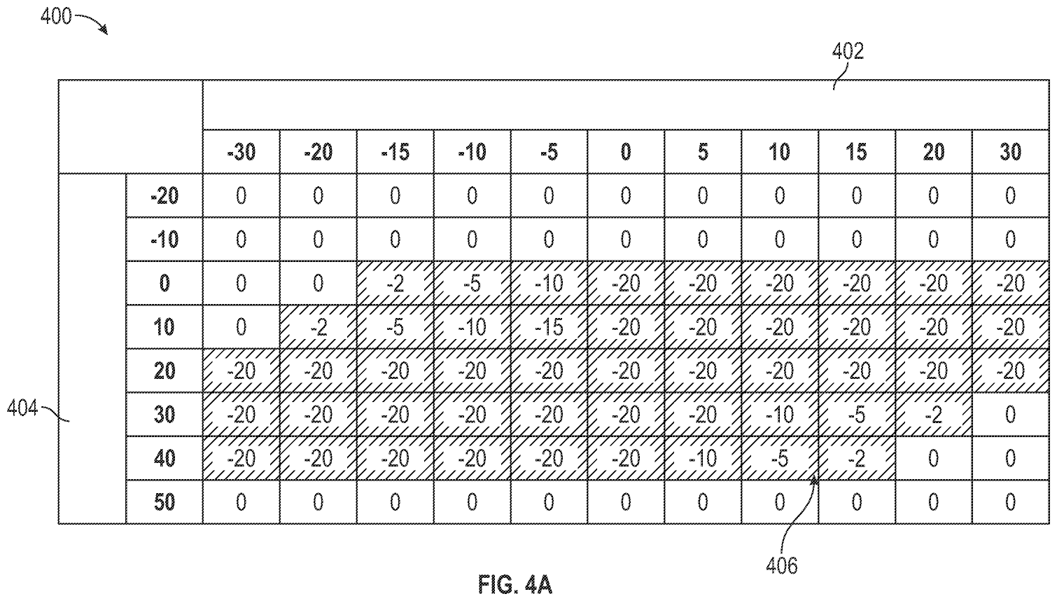

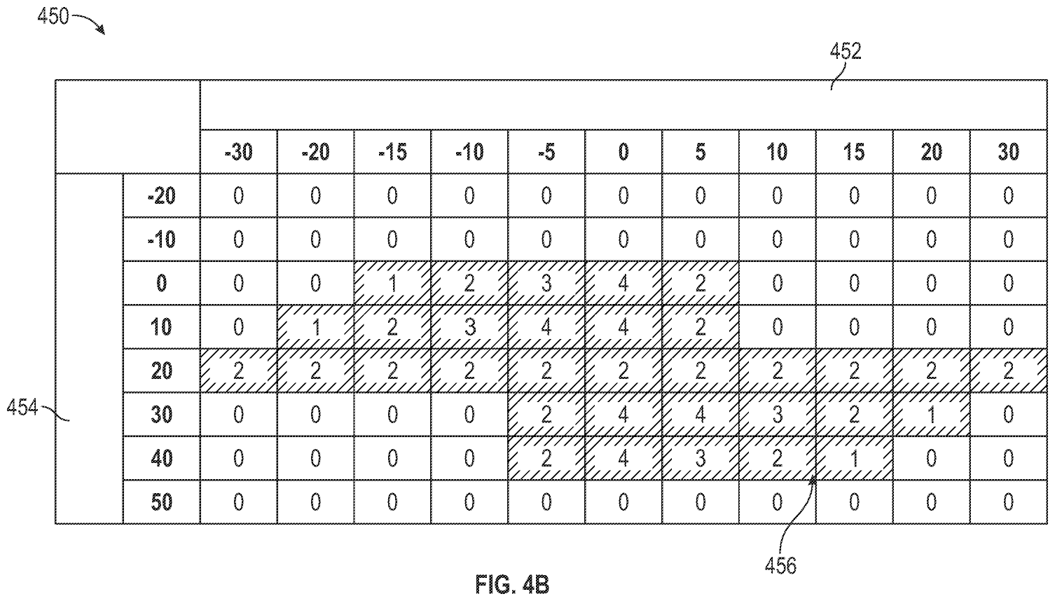

FIG. 1 illustrates a vehicle 100, according to an exemplary embodiment. As described in greater detail further below, the vehicle 100 includes a climate control system 104 and a control system 102 for controlling the climate control system 104 based on passenger occupancy of the vehicle 100, as described in greater detail further below in connection with the vehicle 100 of FIG. 1 as well as the process 200 of FIGS. 2 and 3 and the implementations of FIGS. 4A and 4B.

In various embodiments, the vehicle 100 includes an automobile. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In certain embodiments, the vehicle 100 may also comprise a motorcycle or other vehicle, such as aircraft, spacecraft, watercraft, and so on, and/or one or more other types of mobile platforms (e.g., a robot and/or other mobile platform).

The vehicle 100 includes a body 106 that is arranged on a chassis 108. The body 106 substantially encloses other components of the vehicle 100. The body 106 and the chassis 108 may jointly form a frame. The vehicle 100 also includes a plurality of wheels 110. The wheels 110 are each rotationally coupled to the chassis 108 near a respective corner of the body 106 to facilitate movement of the vehicle 100 via axles 112. In one embodiment, the vehicle 100 includes four wheels 110 and two axles 112, although this may vary in other embodiments (for example for trucks and certain other vehicles).

As depicted in FIG. 1, in various embodiments the vehicle 100 includes one or more windshields 114 and/or other glass components. These may include, by way of example, a front windshield 114, as well as one or more windows (not depicted in FIG. 1), such as one or more passenger side windows, rear windows, and the like.

Also as depicted in FIG. 1, the vehicle 100 includes a cabin 116 that is defined inside the body 106, and in which passengers are located when occupied inside the vehicle 100. As depicted in FIG. 1, in various embodiments, the vehicle 100 also includes various passenger seats 117, including a front row of front seats 118 and one or more rear rows of rear seats 119.

In addition, as depicted in FIG. 1, the vehicle 100 also includes doors 120 through which passengers may enter into and egress out of the cabin 116. As depicted in FIG. 1, in various embodiments, the doors 120 may include one or more front doors 121 (for accessing one or more front seats 118) as well as one or more rear doors 122 (for accessing one or more rear seats 119).

As depicted in FIG. 1, in various embodiments the vehicle 100 also includes various vehicle systems 126 that include, among other systems, a drive system 128 as well as the above-referenced climate control system 104 and control system 102.

In various embodiments, the drive system 128 is mounted on the chassis 108, and drives the wheels 110, for example via the axles 112. In various embodiments, the drive system 128 comprises a propulsion system that includes a motor 129 (e.g., an internal combustion engine and/or an electric motor/generator, coupled with a transmission thereof). In certain embodiments, the drive system 128 and/or associated systems include or are coupled to an accelerator pedal, brake pedal, steering wheel, and the like that receive inputs from a driver of the vehicle 100. In certain embodiments, the drive system 128 and/or associated systems may be automatically controlled via the control system 102 (e.g., for an autonomous vehicle).

In various embodiments, the climate control system 104 provides climate control, including heating and cooling, for the vehicle 100 and/or for components thereof. In certain embodiments, the climate control system 104 comprises a heating, ventilation, and air conditioning (HVAC) system for the vehicle 100.

As depicted in FIG. 1, in various embodiments the climate control system 104 includes one or more elements 130, ducts 132, actuators 134, and/or valves 136, along with one or more blower motors 138 (also referred to herein as blowers 138). In various embodiments, the elements 130 provide heating and/or cooling for air in the cabin 116. In various embodiments, the blower motors 138 generate the flow of air for the climate control system 104. Also in various embodiments, the ducts 132 allow the air (including heating and/or cooled air) to flow into and through the cabin 116, including toward various different seats 117 and/or other regions (including some regions which may be currently occupied by passengers, and certain other regions that may be currently not be occupied by passengers). Also in various embodiments, the actuators 134 and/or valves 136 control the flow of air (including the amount of flow and direction of flow) to and within the cabin 116, including toward and/or away from various different seats 117 and/or regions based at least in part on whether any passengers are currently disposed in such seats 117 and/or regions.

With continued reference to FIG. 1, in various embodiments the control system 102 controls operation of the climate control system 104, including based on passenger occupancy inside the vehicle 100. Specifically, in various embodiments, the control system 102 controls the amount and direction of air flow from the climate control system 104 toward or away from specific seats 117 and/or occupants based on occupancy of the vehicle 100 (including whether front seats 118 and/or rear seats 119 are deemed to be occupied or unoccupied, and with respect to associated regions in proximity to such seats), in accordance with the steps of the process 200 of FIGS. 2 and 3 and the implementations of FIGS. 4A and 4B.

As depicted in FIG. 1, in various embodiments, the control system 102 includes a plurality of sensors 140 (e.g., comprising a sensor array), a display 150, and a controller 160.

In various embodiments, the sensor array 140 collects data pertaining to conditions that may affect control of the climate control system 104. In various embodiments, the sensors 140 include one or more occupant sensors 142, input sensors 144, temperature sensors 146, solar load sensors 148, and/or flow sensors 149, among other possible sensors.

In various embodiments, the occupant sensors 142 obtain sensor data that is used for determining passenger occupancy of the vehicle 100, including whether occupants are seated in rear seats 119 of the vehicle 100. In certain embodiments, the occupant sensors 142 may include one or more door sensors that are part of or coupled to one or more doors 120 of the vehicle 100 (e.g., that detect when the front doors 121 and the rear doors 122 are opened and closed). In various embodiments, the occupant sensors 142 may also include one or more seat sensors (e.g., as part of or coupled to one or more passenger seats 117 that detect when occupants are seated thereon) and/or one or more seat belt sensors (e.g., as part of or coupled to seat belts of the passenger seats 117 that detect when the seat belts are fasted by an occupant on the seat 117).

In various embodiments, the input sensors 144 obtain user inputs from a driver and/or one or more other passengers of the vehicle 100, for example as part of a user interface for the vehicle 100. In various embodiments, the input sensors 144 obtain user inputs as to the passenger's request for one or more settings of the climate control system 104, such as one or more temperature settings, airflow settings, and/or user preferences as to whether to activate or deactivate functionality in which the climate control system 104 is adjusted based on passenger occupancy for the vehicle 100. In certain embodiments, the input sensors 144 obtain user inputs as part of a user interface based on the user's engagement with one or more touch screens, buttons, knobs, switches, or the like.

In various embodiments, the temperature sensors 146 obtain sensor data as to temperature values within and/or outside the vehicle 100. In various embodiments, the temperature sensors 146 measure an air temperature inside the cabin 116 of the vehicle 100. Also in various embodiments, the temperature sensors 146 may also measure and/or obtain other temperature values, including an ambient air temperature outside the vehicle 100 and/or a temperature of the windshield 114 and/or other glass components (e.g., windows) of the vehicle 100, and so on.

In various embodiments, an air temperature inside the cabin 116 of the vehicle 100 may also be calculated, by using other temperature sensors inside the cabin 116 of the vehicle 100 such as the solar load sensor 148 on the dashboard of the vehicle 100, a temperature sensor of the windshield 114 and/or other glass components (e.g., windows) of the vehicle 100, and so on.

In certain embodiments, one or more solar load sensors 148 obtain sensor data as to a solar load on the vehicle 100 and/or one or more components of the vehicle 100. In certain embodiments; however, solar load sensors 148 may not be necessary, for example as solar load values may be incorporated directly via one or more other parameters, such as windshield temperature.

In various embodiments, the flow sensors 149 obtain sensor data as to a flow of air within the vehicle 100. In various embodiments, the flow sensors 149 measure a flow of air as it exits the climate control system 104 and enters the cabin 116 of the vehicle 100, and/or obtains parameter values related thereto.

In various embodiments, the flow of air within the vehicle 100 as the air exits the climate control system 104 may be calculated, by using the speed of the blower motor 138 of the climate control system 104, and so on.

In certain embodiments, the display 150 is configured to provide a display that includes information as to the control of the climate control system 104 (e.g., including when the control of the climate control system 104 is being adjusted based on passenger occupancy of the vehicle 100, such as described in greater detail further below in connection with the process 200 of FIGS. 2 and 3 and the implementations of FIGS. 4A and 4B). In various embodiments, the display 150 includes an audio component 152 and a visual component 154 that provide audio and visual notifications, respectively.

In various embodiments, the controller 160 is coupled to the sensors 140 and receives sensor data therefrom. In various embodiments, the controller 160 is further coupled to the climate control system 104, and in certain embodiments one or more other systems of the vehicle 100. In various embodiments, the controller 160 controls the climate control system 104 based on passenger occupancy for the vehicle 100 (including the locations of the occupants inside the vehicle 100, and for example to provide energy savings when passengers are not disposed in the front seats 118 and/or the rear seats 119 of the vehicle 100), including as described further below in connection with the process 200 of FIGS. 2 and 3 and the implementations of FIGS. 4A and 4B.

In various embodiments, the controller 160 comprises a computer system (also referred to herein as computer system 160). In various embodiments, the controller 160 (and, in certain embodiments, the control system 102 itself) is disposed within the body 106 of the vehicle 100. In one embodiment, the control system 102 is mounted on the chassis 108. In certain embodiments, the controller 160 and/or control system 102 and/or one or more components thereof may be disposed outside the body 106, for example on a remote server, in the cloud, or the like.

It will be appreciated that the controller 160 may otherwise differ from the embodiment depicted in FIG. 1. For example, the controller 160 may be coupled to or may otherwise utilize one or more remote computer systems and/or other control systems, for example as part of one or more of the above-identified vehicle 100 devices and systems.

In the depicted embodiment, the computer system of the controller 160 includes a processor 162, a memory 164, an interface 166, a storage device 168, and a bus 170. The processor 162 performs the computation and control functions of the controller 160, and may comprise any type of processor or multiple processors, single integrated circuits such as a microprocessor, or any suitable number of integrated circuit devices and/or circuit boards working in cooperation to accomplish the functions of a processing unit. During operation, the processor 162 executes one or more programs 172 contained within the memory 164 and, as such, controls the general operation of the controller 160 and the computer system of the controller 160, generally in executing the processes described herein, such as the process 200 of FIGS. 2 and 3 and the implementations of FIGS. 4A and 4B and described further below in connection therewith.

The memory 164 can be any type of suitable memory, including various types of non-transitory computer readable storage medium. In certain examples, the memory 164 is located on and/or co-located on the same computer chip as the processor 162. In the depicted embodiment, the memory 164 stores the above-referenced program 172 along with stored values 174 (e.g., look-up tables, thresholds, and/or other values with respect to control of the climate control system 104 of the vehicle 100).

The interface 166 allows communication to the computer system of the controller 160, for example from a system driver and/or another computer system, and can be implemented using any suitable method and apparatus. In one embodiment, the interface 166 obtains the various data from the sensors 140, among other possible data sources. The interface 166 can include one or more network interfaces to communicate with other systems or components. The interface 166 may also include one or more network interfaces to communicate with technicians, and/or one or more storage interfaces to connect to storage apparatuses, such as the storage device 168.

The storage device 168 can be any suitable type of storage apparatus, including various different types of direct access storage and/or other memory devices. In one exemplary embodiment, the storage device 168 comprises a program product from which memory 164 can receive a program 172 that executes one or more embodiments of one or more processes of the present disclosure, such as the steps of the process 200 of FIGS. 2 and 3 and the implementations of FIGS. 4A and 4B and described further below in connection therewith. In another exemplary embodiment, the program product may be directly stored in and/or otherwise accessed by the memory 164 and/or a disk (e.g., disk 176), such as that referenced below.

The bus 170 serves to transmit programs, data, status and other information or signals between the various components of the computer system of the controller 160. The bus 170 can be any suitable physical or logical means of connecting computer systems and components. This includes, but is not limited to, direct hard-wired connections, fiber optics, infrared and wireless bus technologies. During operation, the program 172 is stored in the memory 164 and executed by the processor 162.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 162) to perform and execute the program.

FIG. 2 is a flowchart of process 200 for controlling a climate control system of a vehicle based on occupancy of passengers in the vehicle, in accordance with exemplary embodiments. The process 200 can be implemented in connection with the vehicle 100 of FIG. 1, including the climate control system 104 and the control system 102 of FIG. 1, and components thereof, in accordance with exemplary embodiments.

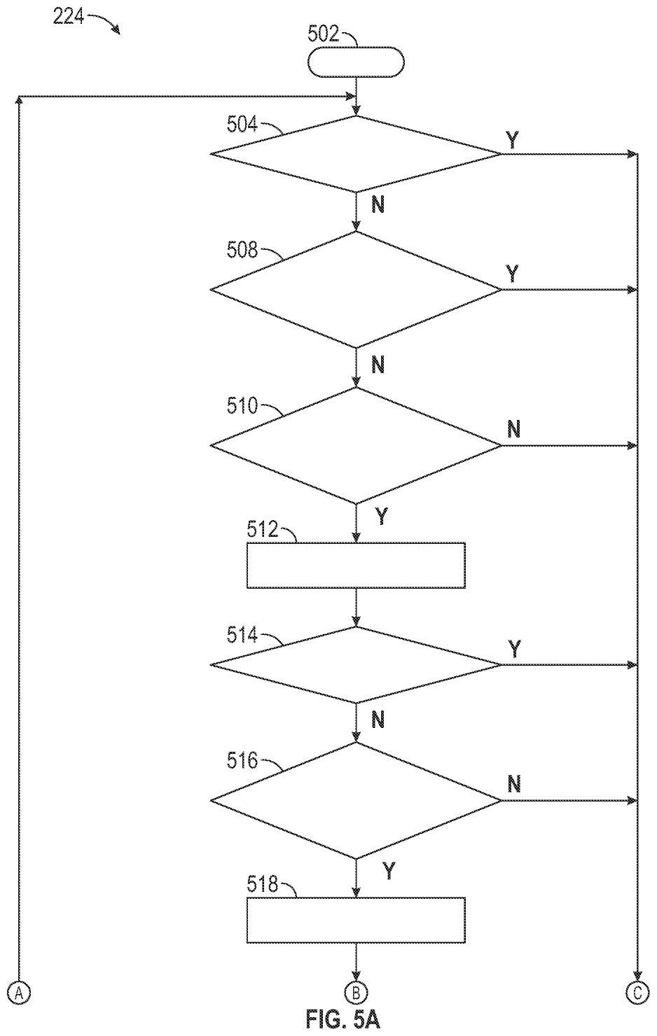

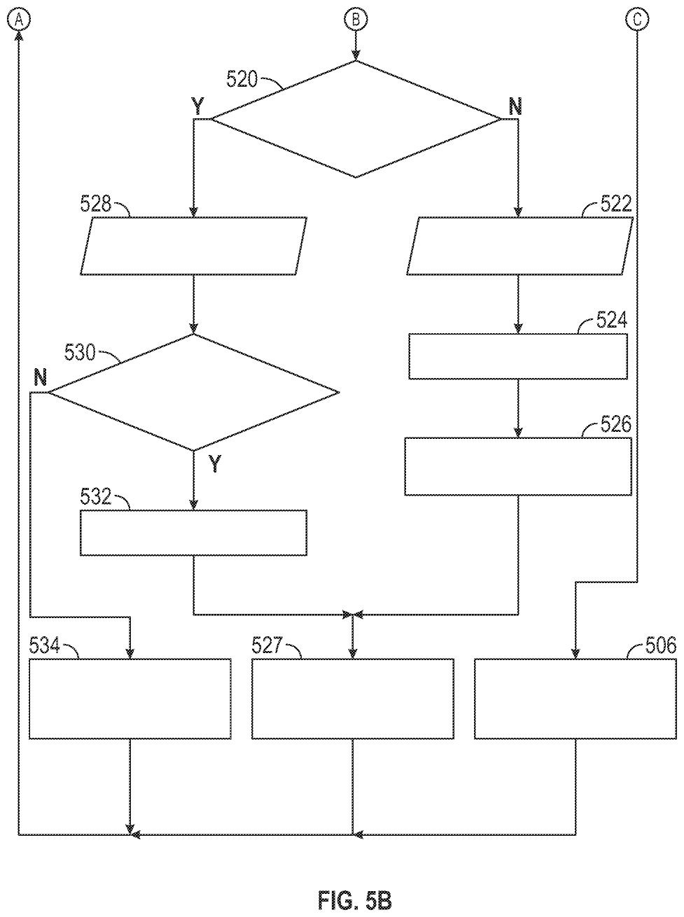

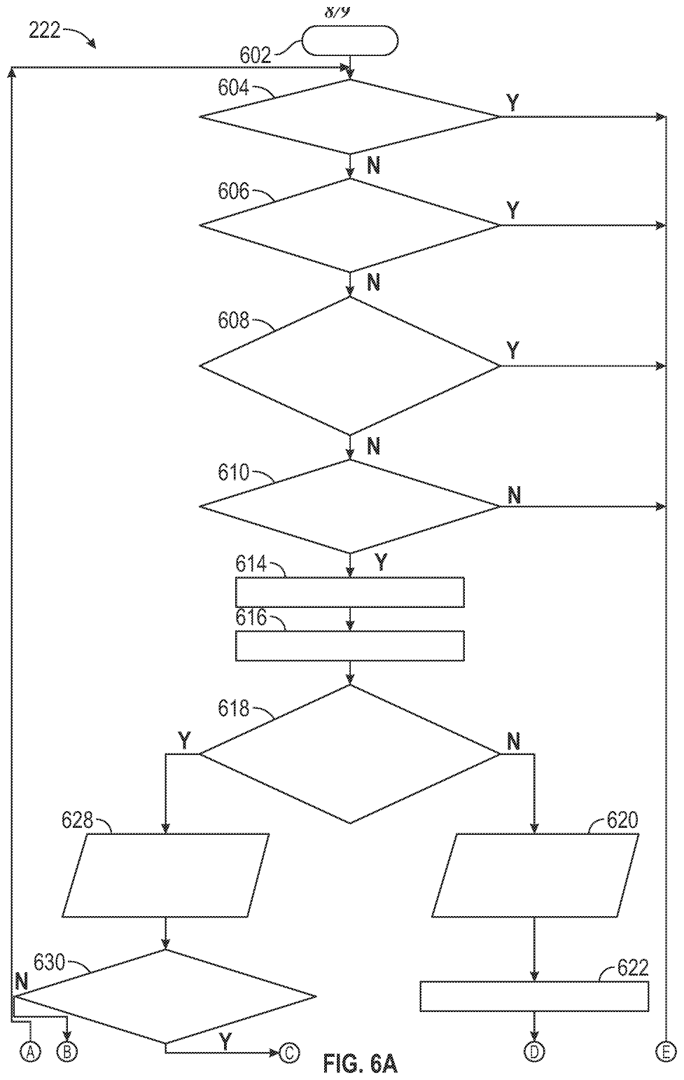

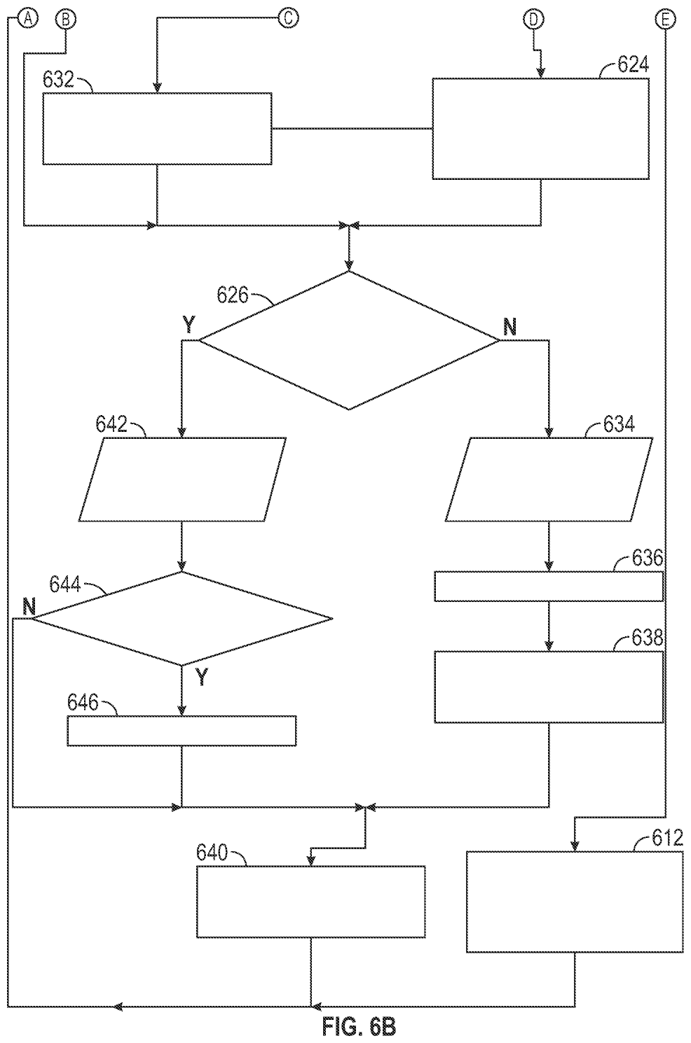

The process 200 will also be described below with reference to FIG. 3 (which provides a flowchart of one of the steps of the process 200 of FIG. 2) as well as FIGS. 4A and 4B (which depict illustrative implementations of the process 200 based on passenger occupancy for the vehicle 100), and in addition to FIGS. 5 and 6 (which depict exemplary implementations of certain steps of the process of FIG. 2, namely, (i) adjusting climate control of occupied regions; and (ii) adjusting climate control of unoccupied regions, respectively), in accordance with exemplary embodiments.

As depicted in FIG. 2, the process 200 begins at step 202. In one embodiment, the process 200 begins when the vehicle 100 is or has been operated, for example during a current vehicle drive. In one embodiment, the steps of the process 200 are performed continuously once the process 200 begins.

In various embodiments, settings are obtained (step 204). In various embodiments, during step 204, user settings are obtained with respect to the climate control system 104, such as a user's preferences as to temperature and/or air flow, and in various embodiments also including whether the user prefers for adjusted control of the climate control system 104 based on passenger occupancy of the vehicle 100. In various embodiments, the settings are retrieved from the memory 164 of FIG. 1 (e.g., from stored values 174 therein) based on one or more current occupants of the vehicle 100 (e.g., based on an identified keyfob or mobile device associated with one or more known users of the vehicle 100, or the like).

Also in various embodiments, sensor data is obtained at step 206. In various embodiments, sensor data pertaining to the vehicle is obtained via the sensors 140 of FIG. 1. In certain embodiments, the sensor data of step 206 includes parameters pertaining to passenger occupancy and location within the vehicle 100 (e.g., via the occupant sensors 142 of FIG. 1); inputs from a driver and/or other passengers of the vehicle 100 as to settings for and operation of the climate control system 104 of FIG. 1 (e.g., via the input sensors 144 of FIG. 1 as part of a user interface for the vehicle 100); temperature values, such as air temperature within the cabin 116 and a temperature of the windshield 114 and/or other glass components (e.g., via the temperature sensors 146 of FIG. 1); in certain embodiments one or more solar load values of the vehicle 100 (e.g., via the solar load sensors 148 of FIG. 1); and one or more air flow values, such as of air exiting the climate control system 104 and entering the cabin 116 of the vehicle 100 (e.g., via the flow sensors 149 of FIG. 1).

In various embodiments, initial control of the climate control system 104 is provided (step 207). Specifically, in various embodiments, initial temperature and air flow settings are provided for the climate control system 104 based on the retrieved settings of step 204 and sensor data (including temperature sensor data) of step 206, without regards to occupancy of the vehicle 100. In various embodiments, the initial control is provided via instructions provided by the processor 162 of FIG. 1 that are implemented via the climate control system 104, such as via the elements 130, actuators 134, and valves 136 thereof of FIG. 1.

In various embodiments, passenger occupancy is determined (step 208). In various embodiments, during step 208, determinations are made as to the locations of occupants inside the vehicle 100. Specifically, in various embodiments, determinations are made as to which seats 117 (and/or rows thereof) are currently occupied by passengers. In one embodiment, these determinations also specifically determine whether or not any occupants are disposed in one or more rows of rear seats 119. In various embodiments, these determinations are made by the processor 162 of FIG. 1 using the sensor data obtained from step 206 via the occupant sensors 142 of FIG. 1.

With reference to FIG. 3, a flowchart is provided for an exemplary embodiment of step 204 of the process 200 of FIG. 2, namely the determining of passenger occupancy for the vehicle 100. In certain embodiments, each of the steps of FIG. 3 are performed separately for each of the seats 117 of the vehicle 100. As depicted in FIG. 3, in various embodiments this occurs after the vehicle 100 has been turned on (step 302).

In various embodiments, a determination is made as to whether seat occupancy sensors (e.g., of the occupant sensors 142 of FIG. 1) are available and valid (step 304). In various embodiments, this determination is made by the processor 162 of FIG. 1.

In various embodiments, if it is determined in step 304 that the seat occupancy sensors are available and valid, then a determination is made as to whether the seat occupancy data indicates that the particular seat is occupied (step 306). In various embodiments, this determination is made by the processor 162 of FIG. 1.

In various embodiments, if it is determined in step 306 that the seat occupancy data indicates that the particular seat is occupied, then that seat is determined to be occupied (step 308). In various embodiments, this is performed by the processor 162 of FIG. 1.

Conversely, in various embodiments, if it is instead determined in step 306 that the seat occupancy data indicates that the particular seat is not occupied, then that seat is determined to be not occupied (step 310). In various embodiments, this is performed by the processor 162 of FIG. 1.

In various embodiments, with reference back to step 304, if it is instead determined in step 304 that the seat occupancy sensors are not available and valid, then a determination is made as to whether data from seat belt sensors (e.g., of the occupant sensors 142 of FIG. 1) are available and valid (step 312). In various embodiments, this determination is made by the processor 162 of FIG. 1.

In various embodiments, if it is determined in step 312 that the seat belt sensors are available and valid, then a determination is made as to whether the seat belt sensor data indicates that the particular seat is occupied (step 314). In various embodiments, this determination is made by the processor 162 of FIG. 1.

In various embodiments, if it is determined in step 314 that the seat belt sensor data indicates that the particular seat is occupied, then that seat is determined to be occupied (as depicted in FIG. 3 with respect to the above-mentioned step 308). In various embodiments, this is performed by the processor 162 of FIG. 1.

Conversely, in various embodiments, if it is instead determined in step 314 that the seat belt sensor data indicates that the particular seat is not occupied, then that seat is determined to be not occupied (as depicted in FIG. 3 with respect to the above-mentioned step 310). In various embodiments, this is performed by the processor 162 of FIG. 1.

In various embodiments, with reference back to step 312, if it is instead determined in step 312 that the seat belt sensors are not available and valid, then a determination is made as to whether data from door sensors (e.g., of the occupant sensors 142 of FIG. 1) indicates that the particular seat is occupied (step 316). For example, in various embodiments, passengers are determined to be located in one or more rear seats 119 when one or more rear doors 122 have been opened and closed just prior to the current vehicle drive and/or the vehicle 100 being turn on. Similarly, by way of additional example, in various embodiments, passengers are determined to be located in one or more front seats 118 when one or more front doors 121 have been opened and closed just prior to the current vehicle drive and/or the vehicle 100 being turn on, and so on.

In various embodiments, if it is determined in step 316 that the door sensor data indicates that the particular seat is occupied, then that seat is determined to be occupied (as depicted in FIG. 3 with respect to the above-mentioned step 308). In various embodiments, this is performed by the processor 162 of FIG. 1.

Conversely, in various embodiments, if it is instead determined in step 316 that the door sensor data indicates that the particular seat is not occupied, then that seat is determined to be not occupied (as depicted in FIG. 3 with respect to the above-mentioned step 310). In various embodiments, this is performed by the processor 162 of FIG. 1.

While FIG. 3 depicts one exemplary implementation of step 208 of FIG. 2 (i.e., of determining passenger occupancy for the vehicle 100), this may vary in other embodiments. For example, in certain embodiments, the passenger occupancy may be determined solely via door sensors, and/or solely via one or more other types of the occupant sensors 142 of FIG. 1, and so on. In any case, in various embodiments, the process 200 then returns to FIG. 2 with step 210 as depicted therein.

With reference back to FIG. 2, in various embodiments, user inputs are determined (step 210). In various embodiments, the user inputs that are obtained include user requests and preferences with respect to the climate control system 104, including any temperature settings and/or air flow settings entered by the user, and further including any user inputs to activate or deactivate functionality for controlling the climate control system 104 based on passenger occupancy for the vehicle 100, and also including whether the user has taken any other actions with respect to the climate control system 104 (e.g., by manually adjusting a temperature and/or airflow setting, and/or by manually opening or closing one or more vents of the climate control system 104, and so on). In various embodiments, the user inputs are determined via the input sensors 144 of FIG. 1 as part of a user interface and/or via the processor 162 of FIG. 1 using values obtained via the input sensors 144.

Also in various embodiments, temperature values are determined (step 212). In various embodiments, the temperature values include an air temperature inside the cabin 116. In certain embodiments, other temperature values may also be determined, such as an ambient air temperature outside the vehicle 100 and/or a temperature of the windshield 114 and/or other glass components (e.g., windows) of the vehicle 100. In various embodiments, the temperature values are determined via the temperature sensors 146 of FIG. 1 and/or via the processor 162 of FIG. 1 using values obtained via the temperature sensors 146.

Also in certain embodiments, solar load values may be determined (step 214). In various embodiments, the solar load values include a solar load against the vehicle 100. In various embodiments, the solar load values may be determined via one or more solar load sensors 148 of FIG. 1 and/or via the processor 162 of FIG. 1 (e.g., based on a windshield temperature of the vehicle 100). In certain embodiments, the solar loads may not be necessary, for example if they are accounted for via the windshield temperature values, and so on.

Also in various embodiments, air flow values are determined (step 216). In various embodiments, the air flow values include a measure (or an estimation) of air flow as it exits the climate control system 104 and enter the cabin 116 of the vehicle 100. In certain embodiments, the air flow values may be directly measured via the flow sensors 149 of FIG. 1. In various other embodiments, the air flow values may be calculated and/or estimated by the processor 162 of FIG. 1 using the sensor data of related values (e.g., which may include, among other possible parameters and values, air flow at one or more other locations, temperature and/or air flow settings of the climate control system 104, and so on).

In various embodiments, a cabin air temperature error is calculated (step 218). In various embodiments, the cabin air temperature error is calculated by the processor 162 of FIG. 1 based on calculating a difference between the air cabin temperature (e.g., from step 212) and a desired cabin temperature for the vehicle 100 (e.g., from settings of step 204 and/or user inputs from step 210).

Also in various embodiments, one or more windshield parameters are calculated (step 220). In various embodiments, the windshield parameters pertain to temperature and/or solar intensity with respect to the windshield 114 of FIG. 1 (and/or, in certain embodiments, one or more windows and/or other glass components of the vehicle 100). In certain embodiments, the windshield parameter is based on the temperature of the windshield 114 (or other glass component), based on direct measurement via one or more temperature sensors 146. In certain other embodiments, the windshield parameters may be based on one or more other parameters such as ambient air outside the vehicle 100 in combination with the solar load. In various embodiments, the one or more windshield parameters are calculated by the processor 162 of FIG. 1 using the sensor data.

In various embodiments, control of the climate control system 104 is initially adjusted based on the passenger occupancy for the vehicle 100 (step 222), and in particular as to the location of occupants in the vehicle 100. Specifically, in certain embodiments, during step 222, the flow of air is adjusted with respect to one or more regions of the vehicle 100 that are deemed to not be occupied by passengers. Specifically, in certain embodiments, the air flow toward unoccupied seats 117 is restricted, turned off, and/or lessened, and in various embodiments air flow is directed away from the unoccupied seats 117 and/or regions surrounding the unoccupied seats 117 in which passengers would have been located if the seats 117 were occupied. In various embodiments, this adjustment in control is executed by the actuators 134 and/or valves 136 in accordance with instructions provided by the processor 162.

Also in various embodiments, during step 222, the adjustment of the air flow serves to reduce power and/or energy consumption based on the occupancy of the vehicle 100, including in a manner that reduces or eliminates air flow toward unoccupied regions and/or seats 117. Also in various embodiments, the adjustments of step 222 are also based at least in part upon (or limited by) the cabin air temperature error of step 218 and the one or more windshield parameters of step 220 (e.g., the windshield temperature). For example, in various embodiments, when the cabin air temperature error and/or windshield temperature exceed one or more predetermined values (and/or together exceed one or more combined predetermined values), the reduction of air flow to the unoccupied seats 117 and/or regions of the vehicle 100 is terminated or lessoned, thereby returning to (or toward) the initial control of step 207.

With respect to FIG. 4A, an exemplary implementation is provided for the adjustment of the control of the climate control system 104 for unoccupied seats 117 and/or unoccupied regions of the vehicle 100, in accordance with an exemplary implementation of step 222. As depicted in FIG. 4A, a graphical representation 400 is provided that includes an x-axis 402 that represents the cabin air temperature error (in degrees Celsius) and a y-axis 404 that represents the windshield temperature (also in degrees Celsius). As depicted in FIG. 4A, in various embodiments, when the cabin air temperature error and/or windshield temperature exceed respective predetermined values (or together exceed a combined predetermined value), as depicted in region 406 of FIG. 4A, then the reduction in airflow to the unoccupied seats 117 and/or regions is terminated or lessened (returning to or toward the initial control of step 207).

With reference back to FIG. 2, in various embodiments, control of the climate control system 104 is further adjusted based on the passenger occupancy for the vehicle 100 (step 224), and in particular as to the location of occupants in the vehicle 100. Specifically, in certain embodiments, during step 224, the flow of air is further adjusted (or boosted) with respect to one or more regions of the vehicle 100 that are deemed to be occupied by passengers. Specifically, in certain embodiments, the air flow toward occupied seats 117 is boosted, or increased, and in various embodiments air flow is directed further toward the occupied seats 117 and/or regions surrounding the occupied seats 117 in which passengers are located. In various embodiments, this boost is performed to further enhance the comfort of current passengers within the vehicle 100 to help offset any general reduction in temperature and/or airflow in step 222 toward the unoccupied regions of the vehicle 100 and that might have had an unintended effect on the comfort of the occupants in the occupied regions of the vehicle 100. In various embodiments, this adjustment in control is executed by the actuators 134 and/or valves 136 in accordance with instructions provided by the processor 162.

Also in various embodiments, the adjustments of step 224 are also based upon the cabin air temperature error of step 218 and the one or more windshield parameters (e.g., the windshield temperature) of step 220. For example, in various embodiments, when the cabin air temperature error and/or windshield temperature exceed one or more predetermined values (and/or when they together exceed one or more combined predetermined values), the boost of airflow is produced accordingly with respect to the occupied seats 117 and/or regions of the vehicle 100.

With respect to FIG. 4B, an exemplary implementation is provided for the adjustment (i.e. boost) of the control of the climate control system 104 for occupied seats 117 and/or regions of the vehicle 100, in accordance with an exemplary implementation of step 224. As depicted in FIG. 4B, a graphical representation 450 is provided with an x-axis 452 that represents the cabin air temperature error (in degrees Celsius) and with a y-axis 454 that represents the windshield temperature (also in degrees Celsius). As depicted in FIG. 4B, in various embodiments, when the cabin air temperature error and/or windshield temperature exceed respective predetermined values (or together exceed a combined predetermined value), as depicted in region 456 of FIG. 4B, the airflow to the occupied seats 117 and/or regions is boosted or increased accordingly in accordance with step 224.

With reference back to FIG. 2, during steps 222 and 224, in various embodiments the initial reduction of airflow to the unoccupied regions of step 222 is relatively larger as compared with the subsequent boost of airflow to the occupied regions of step 224. In accordance with various embodiments, this underscores one of the features of the process 200, whereby the comfort of the present occupants of the vehicle 100 may be maintained while still reducing power and/or energy consumption for the vehicle 100. Consequently, in various embodiments, the passenger comfort may still be maintained while still reducing carbon and/or other emissions (e.g., in the case of a combustion engine) and/or while increasing driving range for a particular amount of charge (e.g., in the case of an electric vehicle), and so on.

With continued reference to FIG. 2, in certain embodiments the adjustments of steps 222 and 224 are terminated and/or reversed when an override is initiated by a user of the vehicle 100 with respect to the control adjustments (step 225). In various embodiments, this occurs when a user (e.g., a passenger inside the vehicle 100) requests an override to the climate settings of one or more unoccupied regions. Specifically, in various embodiments, if at any time the user takes an action that is interpretated as requesting a termination of the adjustment in control of the climate control system 104 based on vehicle occupancy, then a user override is deemed to have occurred. For example, in certain embodiments, if an occupant of the vehicle 100 presses a button or expresses another input (e.g., via a touch screen or other control manner) for deactivation of this feature (i.e., automated adjustments based on occupancy) at any time during steps 222 or 224, then in various embodiments the processor 162 will cause the termination of the adjustments of steps 222 and 224, and in certain embodiments will also cause the reversal of these adjustments and the return of the control of the climate control system 104 to the initial control settings of step 207. In addition, in certain embodiments, the processor 162 will similarly return the control of the climate control system 104 to the initial control settings of step 207 if one or more passengers take an action that could be interpreted as an implied request for an override, such as when the passenger manually opens or closes a vent and/or changes an airflow and/or temperature setting of the climate control system 104 during and/or in response to the adjustments of steps 222 and/or 224.

In various embodiments a determination is made as to whether the current drive cycle is over (step 226). In various embodiments, this determination is made by the processor 162 of FIG. 1 (e.g., as to whether the vehicle 100 has reached its destination, and/or as to whether the current vehicle drive is complete, or the like).

In various embodiments, if it is determined that the current drive cycle is over, then the process returns to step 206, as sensor data continues to be collected. In various embodiments, the process 200 continues and repeats until a determination is made during an iteration of step 226 that the current drive cycle is over.

In various embodiments, once it is determined that the current drive cycle is over, the process proceeds to step 228. In various during step 228, a determination is made as to whether a user has changed any long term settings for the climate control system 104. For example, in certain embodiments, a change in long term setting would comprise a user input that requests that one or more changes in settings (such as activating or deactivating adjustment of control of the climate control system 104 based on passenger occupancy of the vehicle 100) be applied to future drive cycles for the vehicle 100. In various embodiments, this determination is made by the processor 162 of FIG. 1 based on inputs from the user as detected via the input sensors 144 of FIG. 1 as part of a user interface.

In various embodiments, if it is determined in step 228 that one or more long term settings have been changed, then the changes are stored (step 230). In various embodiments, during step 230, the changes to the long term settings are stored as stored values 174 in the memory 164 of FIG. 1, for use in subsequent drive cycles for the vehicle 100. Conversely, if it is determined in step 238 that no long term settings have been changed, then in various embodiment the prior settings remain unchanged. In either case, in various embodiments, the process 200 then terminates at step 232.

With reference to FIGS. 5A, 5B, and 6A, 6B, additional implementations are provided for certain steps of the process 200 of FIG. 2. For ease of reference, FIGS. 5A and 5B are collectively referred to herein as FIG. 5, as FIGS. 5A and 5B depict a single flowchart that is spread out over two pages. Similarly, for ease of reference, FIGS. 6A and 6B are collectively referred to herein as FIG. 6, as FIGS. 6A and 6B depict a single flowchart that is spread out over two pages.

Specifically, in accordance with various embodiments, FIG. 5 depicts an exemplary implementation of the adjustment step 224 of FIG. 2, in accordance with an exemplary embodiment in which the control of step 224 comprises adjusting climate control of unoccupied regions that correspond to one or more front seats 118 (or rows of front seats 118) of the vehicle 100. In addition, also in accordance with various embodiments, FIG. 6 depicts an exemplary implementation of the adjustment step 222 of FIG. 2, in accordance with an exemplary embodiment in which the control of step 222 comprises adjusting climate control of unoccupied regions that correspond to one or more rear seats 119 (or rows of rear seats 119) of the vehicle 100. In certain embodiments, FIGS. 5 and 6 each correspond to one or both of steps 222 and/or 224.

With reference first to FIG. 5, in an exemplary embodiment, the control of step 224 (and/or, in certain embodiments, step 222) begins at step 502, after which a determination is made as to whether one or more passengers are disposed within a front row of the vehicle 100 (step 504) (e.g., in certain embodiments, in addition to the driver). If it is determined that one or more passengers are disposed in the front row, then the process proceeds to step 506, in which typical or normal climate control is provided for the front row of the vehicle 100 (i.e., without adjustments), including for the driver and the other front row passengers. Conversely, if it is instead determined that a front passenger is not detected, then the process proceeds instead to step 508, described below.

In various embodiments, during step 508, a determination is made as to whether climate control settings have been changed (e.g., via user inputs) by or as to a driver and/or passenger in the front row of the vehicle 100. If it is determined that such a control setting has been changed, then then the process proceeds to step 506, in which typical or normal climate control is provided for the front row of the vehicle 100 (i.e., without adjustments). Conversely, if it is instead determined that such a control setting has not been changed, then the process proceeds instead to step 510, described below.

In various embodiments, during step 510, a determination is made as to whether a front blower 138 of the climate control system 104 is on (i.e., to transmit air to a front row of the vehicle 100). If it is determined that a front blower 138 is not on, then then the process proceeds to step 506, in which typical or normal climate control is provided for the front row of the vehicle 100 (i.e., without adjustments). Conversely, if it is instead determined that a front blower 138 is on, then the process proceeds instead to step 512, described below.

During step 512, in various embodiments, front row adjustments are enabled for the climate control. Specifically, in certain embodiments, the climate control system 104 is readied to potentially reduce air flow to the front row.

Also in various embodiments, a determination is made as to whether a humidity risk is present (step 514). If it is determined that a humidity risk is present, then the process proceeds to step 506, in which typical or normal climate control is provided for the front row of the vehicle 100 (i.e., without adjustments). Conversely, if it is instead determined that a humidity risk is not present, then the process proceeds instead to step 516, described below.

Also in various embodiments, a determination is made as to whether a current air distribution is compatible with adjustments to the climate control based on passenger occupancy (step 516). If it is determined that the air distribution is not compatible, then the process proceeds to step 506, in which typical or normal climate control is provided for the front row of the vehicle 100 (i.e., without adjustments). Conversely, if it is instead determined that the airflow is compatible, then the process proceeds instead to step 518, described below.

During step 518, in various embodiments, front row adjustments are enabled for the climate control. Specifically, in certain embodiments, the climate control system 104 is adjusted so as to activate reduced air flow to the front row.

Also in various embodiments, a determination is made as to whether a configuration is present for airflow shutoff for the climate control system 104 (step 520). If it is determined that the configuration is not present for airflow shutoff, then the process proceeds to step 522, described below. Conversely, if it is instead determined that the configuration is present for airflow shutoff, then the process proceeds instead to step 528, described further below.

During step 522, in various embodiments, once it is determined that the configuration is not present for airflow shutoff, the windshield temperature and cabin air temperature error are calculated. Also in various embodiments, during step 524, airflow is reduced for front passengers, provided that the windshield temperature and cabin air temperature are within respective ranges (for example, as described above in connection with FIG. 2 and FIGS. 4A and 4B). In certain embodiments, the airflow is reduced for front passengers other than the driver. In certain other embodiments, the airflow may be reduced for the entire front row.

Also in various embodiments, during step 526, front passenger temperature adjustments (for heating or cooling) are minimized with respect to the front row, for example to save energy. In certain embodiments, the temperature adjustments are made for front passengers other than the driver. In certain other embodiments, the temperature adjustments may be reduced for the entire front row.

In addition, in various embodiments, airflow and temperature of the air from the climate control system 104 are adjusted as needed to maintain comfort for the driver (step 527), for example as described in greater detail above in connection with FIG. and FIGS. 4A and 4B.

Conversely, with reference back to step 520, if it is determined that the configuration is present for airflow shutoff, then in various embodiments the windshield temperature and cabin air temperature error are calculated (step 528). Also in various embodiments, during step 530, a determination is made as to whether airflow shutoff conditions have been met.

If it is determined in step 530 that airflow shutoff conditions have not been met, then in various embodiments the process proceeds to step 534, in which typical or normal climate control is provided for the front row of the vehicle 100, with respect to the drivers and the other front passengers (i.e., without passenger occupancy adjustments, and similar to the above-described step 506).

Conversely, if it is instead determined in step 530 that airflow shutoff conditions have been met, then in various embodiments airflow is shutoff to the front passengers in the front row (step 532). In certain embodiments, this is performed subject to the windshield temperature and cabin air temperature being within respective ranges (for example, as described above in connection with FIG. 2 and FIGS. 4A and 4B). In certain embodiments, the airflow is reduced for front passengers other than the driver. In certain other embodiments, the airflow may be reduced for the entire front row.

In addition, in various embodiments, the process further proceeds to the above-mentioned step 527, in which airflow and temperature of the air from the climate control system 104 are adjusted as needed to maintain comfort for the driver, for example as described in greater detail above in connection with FIG. and FIGS. 4A and 4B.

With reference next to FIG. 6, in an exemplary embodiment, the control of step 222 (and/or, in certain embodiments, step 224) begins at step 602, after which a determination is made as to whether one or more passengers are disposed within one or more rear rows of the vehicle 100 (step 604). If it is determined that one or more passengers are disposed in the rear rows, then the process proceeds to step 612, in which typical or normal climate control is provided for the front rows of the vehicle 100 (i.e., without adjustments), including for both the driver and other passengers in the front row in certain embodiments. Conversely, if it is instead determined that a rear passenger is not detected, then the process proceeds instead to step 606, described below.

In various embodiments, during step 606, a determination is made as to whether a rear door has been ajar during a current vehicle drive or ignition cycle. If it is determined that a rear door has been ajar, then then the process proceeds to step 612, in which typical or normal climate control is provided for the front row of the vehicle 100 (i.e., without adjustments). Conversely, if it is instead determined that a rear door has not been ajar, then the process proceeds instead to step 608, described below.

In various embodiments, during step 608, a determination is made as to whether any climate control settings have changed (e.g., via user input) by or as to a passenger in the rear rows of the vehicle 100. If it is determined that such a control setting has been changed, then then the process proceeds to step 612, in which typical or normal climate control is provided for the front row of the vehicle 100 (i.e., without adjustments). Conversely, if it is instead determined that such a control setting has not been changed, then the process proceeds instead to step 610, described below.

In various embodiments, during step 610, a determination is made as to whether a front blower 138 of the climate control system 104 is on (i.e., to transmit air to a front row of the vehicle 100). If it is determined that a front blower 138 is not on, then then the process proceeds to step 612, in which typical or normal climate control is provided for the front row of the vehicle 100 (i.e., without adjustments). Conversely, if it is instead determined that a front blower 138 is on, then the process proceeds instead to step 614, described below.

During step 614, in various embodiments, rear row adjustments are enabled for the climate control. Specifically, in certain embodiments, the climate control system 104 is readied to potentially reduce air flow to the rear row(s) of the vehicle 100.

Also in various embodiments, during step 616, rear row adjustments are activated for the climate control. Specifically, in certain embodiments, activation is performed for the climate control system 104 so as to reduce air flow to the rear row.

Also in various embodiments, a determination is made as to whether a configuration is present for rear airflow shutoff for the climate control system 104 (step 618). In various embodiments, this determination of step 618 pertains to whether a configuration is present for rear airflow shutoff for the climate control system 104 to a particular rear row (i.e., to a second row of the vehicle 100 in an exemplary embodiment).

If it is determined during step 618 that the configuration is not present for rear airflow shutoff, then the process proceeds to step 620, in which the windshield temperature and cabin air temperature error are calculated. Also in various embodiments, during step 622, airflow is reduced for rear passengers (i.e., for the second row), provided that the windshield temperature and cabin air temperature are within respective ranges (for example, as described above in connection with FIG. 2 and FIGS. 4A and 4B). Also in certain embodiments, during step 624, rear passenger temperature adjustments (for heating or cooling) are minimized with respect to the rear row (i.e., the second row), for example to save energy. In various embodiments, the process then proceeds to step 626, described further below.

With reference back to step 618, if it is instead determined in step 618 that the configuration is present for rear airflow shutoff, then the process proceeds instead to step 628, in which the windshield temperature and cabin air temperature error are calculated. Also in various embodiments, during step 630, a determination is made as to whether rear airflow shutoff conditions are satisfied (i.e., for the second row). In various embodiments, if it is determined in step 630 that rear airflow shutoff conditions are satisfied, then air flow is shut off to the rear passengers (i.e., to the second row) (step 632), after which the process proceeds to step 626. Conversely, in various embodiments, if it is instead determined in step 630 that rear airflow shutoff conditions are not satisfied, then air flow is not shut off to the rear passengers (i.e., to the second row), and instead the process proceeds directly to step 626, described below.

During step 626, in various embodiments, a determination is made as to whether a configuration is present for rear airflow shutoff for the climate control system 104 for a different particular rear row. In various embodiments, this determination of step 626 pertains to whether a configuration is present for rear airflow shutoff for the climate control system 104 to a different particular rear row (i.e., to a third row of the vehicle 100 in an exemplary embodiment).

If it is determined during step 626 that the configuration is not present for rear airflow shutoff to the additional rear row (i.e., the third row), then the process proceeds to step 634, in which the windshield temperature and cabin air temperature error are calculated. Also in various embodiments, during step 634, airflow is reduced for rear passengers (i.e., for the third row), provided that the windshield temperature and cabin air temperature are within respective ranges (for example, as described above in connection with FIG. 2 and FIGS. 4A and 4B). Also in certain embodiments, during step 636, rear passenger temperature adjustments (for heating or cooling) are minimized with respect to the additional rear row (i.e., the third row), for example to save energy. In various embodiments, the process then proceeds to step 640, described further below.

With reference back to step 626, if it is instead determined in step 626 that the configuration is present for rear airflow shutoff to the additional rear row (i.e., the third row), then the process proceeds instead to step 642, in which the windshield temperature and cabin air temperature error are calculated. Also in various embodiments, during step 644, a determination is made as to whether rear airflow shutoff conditions are satisfied (i.e., for the third row). In various embodiments, if it is determined in step 644 that rear airflow shutoff conditions are satisfied, then air flow is shut off to the rear passengers (i.e., to the third row) (step 646), after which the process proceeds to step 640. Conversely, in various embodiments, if it is instead determined in step 644 that rear airflow shutoff conditions are not satisfied, then air flow is not shut off to the rear passengers (i.e., to the third row), and instead the process proceeds directly to step 640, described below.

In various embodiments, during step 640, the climate control setting is adjusted with respect to airflow and temperature for comfort of the driver. Specifically, in various embodiments, airflow is increased toward the driver of the vehicle 100 (and/or in general to the first row of the vehicle 100). Also in various embodiments, temperature is adjusted accordingly to maintain the comfort of the driver (and/or in general to the first row of the vehicle 100).

In various embodiments, the process returns to step 604, and the steps repeat.

Accordingly, in various embodiments, systems and methods are provided for controlling a climate control system of a vehicle based on occupancy of the vehicle. In various embodiments, air flow is reduced, turned off, and/or redirected away from unoccupied seats of the vehicle and/or unoccupied regions in which passengers are not presently located. In various embodiments, a boost may then be implemented for the occupied seats and/or regions of the vehicle, for example to account for unaccounted consequences of the reduction in air flow to the unoccupied seats and/or regions. In addition, in various embodiments, the adjustments may also be based in part on other parameters such as cabin air temperature error and/or windshield temperature for the vehicle. In various embodiments, the systems and methods allow for the maintenance of the desired comfort for the current occupants of the vehicle while also potentially reducing energy and/or power usage, and to thereby reduce emissions and/or extend driving range for the vehicle in different embodiments.

It will be appreciated that the systems, vehicles, and methods may vary from those depicted in the Figures and described herein. For example, the vehicle 100 of FIG. 1, the control system 102, and climate control system 104 thereof, and/or components thereof of FIG. 1 may vary in different embodiments. It will similarly be appreciated that the steps of the process 200 may differ from that depicted in FIGS. 2 and 3, and/or that various steps of the process 200 may occur concurrently and/or in a different order than that depicted in FIGS. 2 and 3. It will also be appreciated that the implementations of FIGS. 4A and 4B may also vary in different embodiments.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method comprising:
obtaining sensor data via one or more sensors of a vehicle as to a location of one or more passengers in the vehicle; and
controlling, via instructions provided by a processor, a climate control system of the vehicle based on the location of the one or more passengers in the vehicle.

2. The method of claim 1, further comprising:
determining, via the processor, one or more unoccupied regions of the vehicle, based on the sensor data; and
restricting, via the instructions provided by the processor, air flow from the climate control system to the one or more unoccupied regions.

3. The method of claim 2, further comprising:
obtaining additional sensor data pertaining to climate control of the vehicle, including temperature data via one or more temperature sensors and user inputs via one or more user interfaces;
calculating, via the processor a cabin air temperature error based on the additional sensor data; and
limiting the restricting of the air flow to the one or more unoccupied regions, via the instructions providing by the processor, based on the cabin air temperature error.

4. The method of claim 3, further comprising:
determining, via the processor, a temperature of a windshield of the vehicle based on the additional sensor data; and
further limiting the restricting of the air flow to the one or more unoccupied regions, via the instructions providing by the processor, based also on the temperature of the windshield.

5. The method of claim 2, further comprising:
determining, via the processor, when a user override has occurred to the climate settings of one or more unoccupied regions; and
terminating the restricting of the air flow to the one or more unoccupied regions, via the instructions providing by the processor, when the user override is determined to have occurred.

6. The method of claim 2, further comprising:
determining, via the processor, one or more occupied regions of the vehicle, based on the sensor data; and
increasing, via the instructions provided by the processor, the air flow from the climate control system to the one or more occupied regions.

7. The method of claim 6, further comprising:
obtaining additional sensor data pertaining to climate control of the vehicle, including temperature data via one or more temperature sensors and user inputs via one or more user interfaces;
calculating, via the processor a cabin air temperature error based on the additional sensor data;
determining, via the processor, a temperature of a windshield of the vehicle based on the additional sensor data; and
limiting the increasing of the air flow to the one or more occupied regions, via the instructions providing by the processor, based on the cabin air temperature error and the temperature of the windshield.

8. The method of claim 2, wherein:
the step of determining the one or more unoccupied regions comprises determining one or more unoccupied seats of the vehicle based on the sensor data; and
the step of restricting the air flow comprises restricting, via the instructions provided by the processor, the air flow from the climate control system to the one or more unoccupied seats.

9. The method of claim 8, wherein:
the step of obtaining the sensor data comprises door sensor data that is representative of opening and closing one or more doors of the vehicle, via one or more door sensors of the vehicle; and
the step of determining the one or more unoccupied seats comprises determining, via the processor, the one or more unoccupied seats based on the door sensor data.

10. A system comprising:
one or more sensors configured to obtain sensor data as to a location of one or more passengers in a vehicle; and
a processor that is coupled to the one or more sensors and that is configured to at least facilitate controlling, via instructions provided by the processor, a climate control system of the vehicle based on the location of the one or more passengers in the vehicle.

11. The system of claim 10, wherein the processor is further configured to at least facilitate:
determining one or more unoccupied regions of the vehicle, based on the sensor data; and
restricting, via the instructions provided by the processor, air flow from the climate control system to the one or more unoccupied regions.

12. The system of claim 11, further comprising:
additional sensors configured to obtain additional sensor data pertaining to climate control of the vehicle, wherein the additional sensors include:
one or more temperature sensors configured to obtain temperature data; and
one or more user interfaces configured to obtain user inputs;
wherein the processor is further configured to at least facilitate:
calculating a cabin air temperature error based on the additional sensor data; and
limiting the restricting of the air flow to the one or more unoccupied regions, via the instructions providing by the processor, based on the cabin air temperature error.

13. The system of claim 12, wherein the processor is further configured to at least facilitate:
determining a temperature of a windshield of the vehicle based on the additional sensor data; and
further limiting the restricting of the air flow to the one or more unoccupied regions, via the instructions providing by the processor, based also on the temperature of the windshield.

14. The system of claim 11, wherein the processor is further configured to at least facilitate:
determining when a user override has occurred to the climate settings of one or more unoccupied regions, using the additional sensor data; and
terminating the restricting of the air flow to the one or more unoccupied regions, via the instructions providing by the processor, when the user override is determined to have occurred.

15. The system of claim 11, wherein the processor is further configured to at least facilitate:
determining one or more occupied regions of the vehicle, based on the sensor data; and
increasing, via the instructions provided by the processor, the air flow from the climate control system to the one or more occupied regions.

16. The system of claim 15, further comprising:
additional sensors configured to obtain additional sensor data pertaining to climate control of the vehicle, wherein the additional sensors include:
one or more temperature sensors configured to obtain temperature data; and
one or more user interfaces configured to obtain user inputs;
wherein the processor is further configured to at least facilitate:
calculating a cabin air temperature error based on the additional sensor data;
determining, via the processor, a temperature of a windshield of the vehicle based on the additional sensor data; and
limiting the increasing of the air flow to the one or more occupied regions, via the instructions providing by the processor, based on the cabin air temperature error and the temperature of the windshield.

17. The system of claim 11, wherein the processor is further configured to at least facilitate:
determining one or more unoccupied seats of the vehicle based on the sensor data; and
restricting, via the instructions provided by the processor, the air flow from the climate control system to the one or more unoccupied seats.

18. The system of claim 17, wherein:
the one or more sensors comprise one or more door sensors configured to obtain door sensor data that is representative of opening and closing one or more doors of the vehicle; and
the processor is further configured to at least facilitate determining, via the processor, the one or more unoccupied seats based on the door sensor data.

19. A vehicle comprising:
a climate control system:
one or more sensors configured to obtain sensor data as to a location of one or more passengers in the vehicle; and
a processor that is coupled to the one or more sensors and that is configured to at least facilitate controlling, via instructions provided by the processor, the climate control system based on the location of the one or more passengers in the vehicle.

20. The vehicle of claim 19, further comprising:
one or more doors;
wherein:
the one or more sensors comprise one or more door sensors that are configured to obtain door sensor data that is representative of opening and closing one or more of the doors of the vehicle; and
the processor is further configured to at least facilitate:
determining one or more unoccupied seats of the vehicle based on the door sensor data; and
restricting, via the instructions provided by the processor, air flow from the climate control system to the one or more unoccupied seats.
